(19) United States
(12) Patent Application Publication
(10) Pub. No.: US 2007/0245087 A1
(43) Pub. Date: Oct. 18, 2007

(54) Data buffer device, cache device, and data buffer control method

(75) Inventor: Hideki Sakata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 11/802,069

(22) Filed: May 18, 2007

Related U.S. Application Data
(63) Continuation of application No. PCT/JP04/17923, filed on Dec. 2, 2004.

(51) Int. Cl. G06F 12/00

(52) U.S. Cl. 711/119

(57) ABSTRACT

There is disclosed a data buffer device that selects and uses buffers to improve persistence of data and uniformity in use frequency of the buffers. The data buffer device includes: a REQ_QUEUE 11 constituted by plural buffers that store data and are given numbers; a mask bit vector 12 that has mask bit patterns to mask the plural buffers, respectively, and sets corresponding one of the mask bit patterns for a released buffer among the plural buffers; a first priority select section 13 that selects a buffer given the smallest number from buffers that are neither masked by the mask bit vector nor used among the plural buffers; a second priority select section 14 that selects a buffer given the smallest number from unused buffers among the plural buffers; and a selector 15 that selects one of the buffer selected by the first priority select section 13 and the buffer selected by the second priority select section 14.

### TECHNICAL FIELD

The present invention relates to a data buffer device, a cache device, and a data buffer control method of improving persistence of data and uniformity of use frequency.

### RELATED ART

RIRO type (Random In Random Out) data buffer commonly adopts control using a priority selection system. Buffers to be released are randomly selected in the RIRO type data buffers controlled under the priority selection system. Buffers are selected in order from one given the smallest number. FIGS. 14A, 14B, and 14C show an example of specific operation of buffer control according to a conventional priority selection system. These figures respectively show first to third states in this order. Total four buffers are used and given buffer numbers are 1 to 4. For each buffer number, “unused (empty)”, “used”, or an identifier “a” indicative of residual data is indicated.

At first, buffers 1, 2, and 3 are set to “used” as shown in FIG. 14A. Next, if the buffer 2 is released as in the second state shown in FIG. 14B, the data a remains in the buffer 2. Next, if the buffers are used as in the third state shown in FIG. 14C, an empty buffer denoted at the smallest number is used. Therefore, the data of the buffer 2 which has been just used is overwritten immediately and then lost.

As described above, in the conventional priority selection system, the buffer denoted at the smallest number is frequently used and past data does not remain. Further, since use frequencies are unbalanced between individual buffers, operation errors can be detected late if operation errors occur in a buffer assigned to a greater number.

To solve this problem, FIFO (First In First Out) type data buffers popularly use buffer control based on a counter. FIGS. 15A, 15B, and 15C show an example of specific operation of buffer control using a counter in conventional FIFO type data buffers. These figures respectively show first to third states in this order. Total four buffers are used and given buffer numbers are 1 to 4. For each buffer number, “unused (empty)”, “used”, or an identifier “a” indicative of residual data is indicated. FIFO type data buffers have an in counter and an out counter. The in counter indicates a buffer number of a buffer to which data is to be written. The out counter indicates a buffer number of a buffer from which data is to be read.

At first, as in the first state shown in FIG. 15A, all buffers are unused in the initial state. Both of the in and out counters indicate 1. Next, as in the second state shown in FIG. 15B, if the buffer 1 indicated by the in counter is used, the in counter counts up. Next, if data is read from a buffer indicated by the out counter as in the third state shown in FIG. 15C, the out counter counts up and releases the buffer. Data remains until a next turn of the buffer comes although data cannot be extracted at random.

However, if such control using a counter is employed in RIRO type data buffers, an unused buffer is used again when a counter designates the unused buffer. Therefore, use efficiency of buffers degrades extremely.

For strict order control, PM (Precedence Matrix) and LRU (Least Recently Used) are used. The PM system will now be described. When a buffer is used, the buffer records that the buffer itself is the newest. When a buffer is released, the buffer records that the buffer is older than the buffer being used.

FIGS. 16A, 16B, 16C, 17D, 17E, 17F, 18G, 18H, and 18I show an example of specific operation of the buffer control according to the conventional PM system. These figures respectively show first to ninth states in this order. Total four buffers are used and given buffer numbers are 1 to 4. States of the buffers each are expressed as a matrix of 4×4. Where x (1 to 4) is the buffer number in the column direction and y (1 to 4) is the buffer number in the row direction, “1” indicates a state in which x is older than y. In the right side of the 4×4 matrix, “unused (empty)”, “used”, or an identifier “a, b, c, or d” indicative of residual data is indicated.

At first, as in the first state shown in FIG. 16A, all buffers are unused in the initial state, so that all states are “0”. Although use order is arbitrary in the initial state, the buffers are supposed to be used in order from one given the smallest number. Next, the buffer 1 is used as in the second state shown in FIG. 16B. All states at y=1 are then “1” which indicates that the buffer 1 is the newest. Next, the buffers 2, 3, and 4 are used in order as in the third state shown in FIG. 16C. The matrix indicates that the buffer 3 is older than the buffer 4, the buffer 2 than the buffer 3, as well as the buffer 1 than the buffer 2. Next, the buffer 3 is released as in the fourth state shown in FIG. 17D, the matrix indicates that the data a remaining in the buffer 3 is the oldest. Next, the buffer 1 is released as in the fifth state shown in FIG. 17E. The matrix then indicates that the data b remaining in the buffer 1 is the second oldest next to the data a.

That is, the more “1” a line denoted at a buffer number in a state includes, the older the data remaining in the corresponding buffer is. The corresponding buffer is dealt with as a target to store data next. Next, the buffer 4 is released as in the sixth state shown in FIG. 17F. The matrix then expresses that the buffer 3 is the target to store data next. Next, the buffer 3 is used as in the seventh state shown in FIG. 18G. The line of the buffer 3 is reset. Next, the buffer 2 is released as in the eighth state shown in FIG. 18H. The matrix then expresses that the buffer 1 is the target to store data next. Next, the buffer 1 is used as in the ninth state shown in FIG. 18I. The matrix then expresses that the buffer 4 is the target to store data.

However, the PM system as described above has an effective feature that order can be controlled strictly. On the other side, the PM system requires (nˆ2)−n latches for controlling n buffers in addition to complex logic of the system. Therefore, the PM system causes increase in exponential circuit scale.

For example, Jpn. Pat. Appln. Laid-Open Publication No. 2003-84999 (pages 3 to 5 and FIG. 1) is known as a conventional technique related to the present invention.

### DISCLOSURE OF THE INVENTION

Problems to be Solved by the Invention

Devices using a conventional data buffer are involving a problem that time required for verifying a design or checking a malfunction extends longer. As a factor causing this problem is that necessary and sufficient information can not be obtained or is lost. In addition, in the RIRO type data buffers as described above, use frequencies vary between data buffers due to its structure. Therefore, even devices including defects at parts which are less frequently used can pass tests. Thus, there can be omissions in running tests.

The present invention has been made to address the above problems and is directed to providing a data buffer device, a cache device, and a data buffer control method which allow information necessary for verifications or inspections to remain and equalize use frequencies, thereby to improve test efficiency.

Means for Solving the Problem

According to one aspect of the invention to address the above problems, there is provided a data buffer device that selects and uses buffers to improve persistence of data and uniformity in use frequency of the buffers, the device including: plural buffers that store data and are given numbers; a mask bit vector that has mask bit patterns to mask the plural buffers, respectively, and sets corresponding one of the mask bit patterns for a released buffer among the plural buffers; and a priority select section that selects a buffer given the smallest number from buffers that are neither masked by the mask bit vector nor used among the plural buffers.

Preferably in the data buffer device, if. there is no non-masked and unused buffer, the mask bit vector is reset.

According to another aspect of the invention, there is provided a data buffer device that selects and uses buffers to improve persistence of data and uniformity in use frequency of the buffers, the device including: plural buffers that store data and are given numbers; a mask bit vector that has mask bit patterns to mask the plural buffers, respectively, and sets corresponding one of the mask bit patterns for a released buffer among the plural buffers; a first priority select section that selects a buffer given the smallest number from buffers that are neither masked by the mask bit vector nor used among the plural buffers; a second priority select section that selects a buffer given the smallest number from unused buffers among the plural buffers; and a selector that selects one of the buffer selected by the first priority select section and the buffer selected by the second priority select section.

Preferably in the data buffer device, if all of the plural buffers are masked, the mask bit vector is reset.

According to further another aspect of the invention, there is provided a data buffer device that selects and uses buffers to improve persistence of data and uniformity in use frequency of the buffers, the device including: plural buffers that store data and are given numbers; a mask bit vector that has mask bit patterns to mask the plural buffers, respectively, and sets corresponding one of the mask bit patterns for a released buffer among the plural buffers; a first priority select section that selects a buffer given the smallest number from buffers that are neither masked by the mask bit vector nor used among the plural buffers; and a second priority select section that selects, if the first priority select section selects no buffer, a buffer given the smallest number from unused buffers among the plural buffers.

According to still another aspect of the invention, there is provided a cache device that selects and uses buffers to improve persistence of request and uniformity in use frequency of the buffers, the device including: plural buffers that store requests and are given numbers; a mask bit vector that has mask bit patterns to mask the plural buffers, respectively, and sets corresponding one of the mask bit patterns for a released buffer among the plural buffers; a priority select section that selects a buffer given the smallest number from buffers that are neither masked by the mask bit vector nor used among the plural buffers; a request processing section that processes one after another of the requests stored in the buffers; and a data section that reads or writes data in response to the requests processed by the request processing section.

According to still another aspect of the invention, there is provided a cache device that selects and uses buffers to improve persistence of request and uniformity in use frequency of the buffers, the device including: plural buffers that store requests and are given numbers; a mask bit vector that has mask bit patterns to mask the plural buffers, respectively, and sets corresponding one of the mask bit patterns for a released buffer among the plural buffers; a first priority select section that selects a buffer given the smallest number from buffers that are neither masked by the mask bit vector nor used among the plural buffers; a second priority select section that selects a buffer given the smallest number from unused buffers among the plural buffers; a selector that selects one of the buffer selected by the first priority select section and the buffer selected by the second priority select section; a request processing section that processes one after another of the requests stored in the buffers; and a data section that reads or writes data in response to the requests processed by the request processing section.

According to still another aspect of the invention, there is provided a cache device that selects and uses buffers to improve persistence of request and uniformity in use frequency of the buffers, the device including: plural buffers that store requests and are given numbers; a mask bit vector that has mask bit patterns to mask the plural buffers, respectively, and sets corresponding one of the mask bit patterns for a released buffer among the plural buffers; a first priority select section that selects a buffer given the smallest number from buffers that are neither masked by the mask bit vector nor used among the plural buffers; a second priority select section that selects, if the first priority select section selects no buffer, a buffer given the smallest number from unused buffers among the plural buffers; a request processing section that processes one after another of the requests stored in the buffers; and a data section that reads or writes data in response to the requests processed by the request processing section.

According to still another aspect of the invention, there is provided a data buffer control method that selects and uses buffers to improve persistence of data and uniformity in use frequency of the buffers, the method including: a mask step that has mask bit patterns to mask the plural buffers, respectively, and sets corresponding one of the mask bit patterns for a released buffer among the plural buffers; and a priority select step that selects a buffer given the smallest number from buffers that are neither masked by the mask step nor used among the plural buffers.

The data buffer control method preferably further includes a mask reset step that resets all of the mask bit patterns if there is not a buffer any more that is neither masked nor used among the plural buffers.

According to still another aspect of the invention, there is provided a data buffer control method that selects and uses buffers to improve persistence of data and uniformity in use frequency of the buffers, the method including: a mask step that has mask bit patterns to mask the plural buffers, respectively, and sets corresponding one of the mask bit patterns for a released buffer among the plural buffers; a first priority select step that selects a buffer given the smallest number from buffers that are neither masked by the mask step nor used among the plural buffers; a second priority select step that selects a buffer given the smallest number from unused buffers among the plural buffers; and a select step that selects one of the buffer selected by the first priority select step and the buffer selected by the second priority select step.

The data buffer control method preferably further includes a reset step that resets all of the mask bit patterns if there is not a buffer any more that is not masked.

According to still another aspect of the invention, there is provided a data buffer control method that selects and uses buffers to improve persistence of data and uniformity in use frequency of the buffers, the method including: plural buffers that store data and are given numbers; a mask step that has mask bit patterns to mask the plural buffers, respectively, and sets corresponding one of the mask bit patterns for a released buffer among the plural buffers; a first priority select step that selects a buffer given the smallest number from buffers that are neither masked by the mask bit vector nor used among the plural buffers; and a second priority select step that selects, if the first priority select step selects no buffer, a buffer given the smallest number from unused buffers among the plural buffers.

The “plural buffers” described above correspond to the REQ_QUEUE in the embodiments.

### BRIEF DESCRIPTION OF THE DRAWINGS

FIG. 1 is a block diagram showing a configuration of a cache device according to the first embodiment;

FIG. 2 is a flowchart showing an example of operation of the data buffer device according to the first embodiment;

FIG. 3 is a flowchart showing an example of operation of the first priority select section according to the first embodiment;

FIG. 4 is a flowchart showing an example of operation of buffer selection by the first priority select section according to the first embodiment;

FIG. 5 is a flowchart showing an example of operation of buffer selection by the second priority select section according to the first embodiment;

FIG. 6A shows a first state in an example of specific operation of the data buffer device according to the invention;

FIG. 6B shows a second state in the example of specific operation of the data buffer device according to the invention;

FIG. 6C shows a third state in the example of specific operation of the data buffer device according to the invention;

FIG. 6D shows a fourth state in the example of specific operation of the data buffer device according to the invention;

FIG. 6E shows a fifth state in the example of specific operation of the data buffer device according to the invention;

FIG. 7F shows a sixth state in the example of specific operation of the data buffer device according to the invention;

FIG. 7G shows a seventh state in the example of specific operation of the data buffer device according to the invention;

FIG. 8A shows a first state in an example of specific operation relating to resetting of a mask bit vector according to the first embodiment;

FIG. 8B shows a second state in the example of specific operation relating to resetting of the mask bit vector according to the first embodiment;

FIG. 8C shows a third state in the example of specific operation relating to resetting of the mask bit vector according to the first embodiment;

FIG. 8D shows a fourth state in the example of specific operation relating to resetting of the mask bit vector according to the first embodiment;

FIG. 8E shows a fifth state in the example of specific operation relating to resetting of the mask bit vector according to the first embodiment;

FIG. 9F shows a sixth state in the example of specific operation relating to resetting of the mask bit vector according to the first embodiment;

FIG. 9G shows a seventh state in the example of specific operation relating to resetting of the mask bit vector according to the first embodiment;

FIG. 9H shows an eighth state in the example of specific operation relating to resetting of the mask bit vector according to the first embodiment;

FIG. 9I shows a ninth state in the example of specific operation relating to resetting of the mask bit vector according to the first embodiment;

FIG. 10 is a block diagram showing an example of configuration of a cache device according to the second embodiment;

FIG. 11 is a flowchart showing an example of operation of a data buffer device according to the second embodiment;

FIG. 12A shows a first state in an example of specific operation relating to resetting of a mask bit vector according to the second embodiment;

FIG. 12B shows a second state in the example of specific operation relating to resetting of the mask bit vector according to the second embodiment;

FIG. 12C shows a third state in the example of specific operation relating to resetting of the mask bit vector according to the second embodiment;

FIG. 12D shows a fourth state in the example of specific operation relating to resetting of the mask bit vector according to the second embodiment;

FIG. 12E shows a fifth state in the example of specific operation relating to resetting of the mask bit vector according to the second embodiment;

FIG. 13F shows a sixth state in the example of specific operation relating to resetting of the mask bit vector according to the second embodiment;

FIG. 13G shows a seventh state in the example of specific operation relating to resetting of the mask bit vector according to the second embodiment;

FIG. 13H shows an eighth state in the example of specific operation relating to resetting of the mask bit vector according to the second embodiment;

FIG. 13I shows a ninth state in the example of specific operation relating to resetting of the mask bit vector according to the second embodiment;

FIG. 14A shows a first state in an example of specific operation of buffer control according to the conventional priority selection system;

FIG. 14B shows a second state in the example of specific operation of buffer control according to the conventional priority selection system;

FIG. 14C shows a third state in the example of specific operation of buffer control according to the conventional priority selection system;

FIG. 15A shows a first state in an example of specific operation of buffer control according to a conventional FIFO type data buffer using a counter;

FIG. 15B shows a second state in the example of specific operation of buffer control according to the conventional FIFO type data buffer using a counter;

FIG. 15C shows a third state in the example of specific operation of buffer control according to the conventional FIFO type data buffer using a counter;

FIG. 16A shows a first state in an example of specific operation of buffer control according to a conventional PM system;

FIG. 16B shows a second state in the example of specific operation of buffer control according to the conventional PM system;

FIG. 16C shows a third state in the example of specific operation of buffer control according to the conventional PM system;

FIG. 17D shows a fourth state in the example of specific operation of buffer control according to the conventional PM system;

FIG. 17E shows a fifth state in the example of specific operation of buffer control according to the conventional PM system;

FIG. 17F shows a sixth state in the example of specific operation of buffer control according to the conventional PM system;

FIG. 18G shows a seventh state in the example of specific operation of buffer control according to the conventional PM system;

FIG. 18H shows an eighth state in the example of specific operation of buffer control according to the conventional PM system; and

FIG. 18I shows a ninth state in the example of specific operation of buffer control according to the conventional PM system.

### BEST MODE FOR CARRYING OUT THE INVENTION

Hereinafter, embodiments of the present invention will be described with reference to the drawings.

### First Embodiment

At first, a configuration of a cache device having a data buffer device will be described.

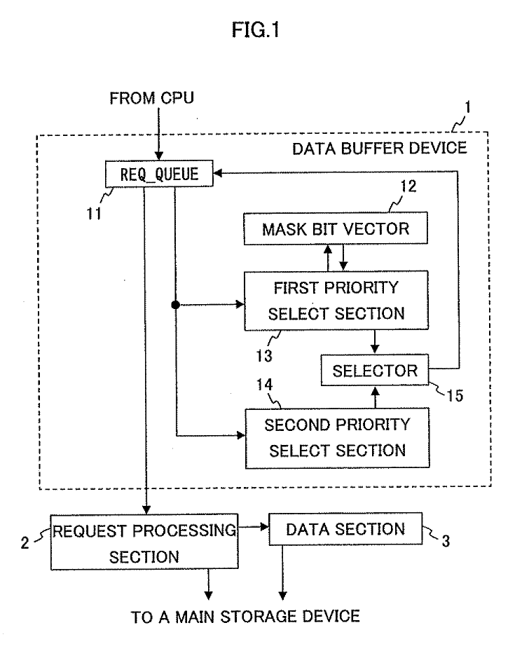

FIG. 1 is a block diagram showing a configuration of a cache device according to the first embodiment. The cache device has a data buffer device 1, a request processing section 2, and a data section 3. This cache device is used, for example, as a secondary cache block for a CPU. In addition, the data buffer device 1 has a REQ_QUEUE 11, a mask bit vector 12, a first priority select section unit 13, a second priority select section 14, and a selector 15.

The REQ_QUEUE 11 is constituted by n buffers (where n is an integer) and stores requests from the CPU. Stored requests are supplied one after another to the request processing section 2. Data is read from or written into a main storage device by a data section 3 in response to the requests. Processed requests are erased from the REQ_QUEUE 11. If processing is not completed due to an interlock or the like, the request is supplied again to the request processing section 2 from the REQ_QUEUE 11, and the processing is automatically reexecuted. At this time, processing is completed regardless of order of supplied requests. Therefore, the REQ_QUEUE 11 is constituted by RIRO type buffers.

The mask-bit vector 12 has n mask bit patterns and masks a released buffer when releasing the buffer. That is, a mask bit pattern corresponding to a released buffer is set to “1”. In this embodiment, the mask bit vector 12 is reset to all “0” if all buffers are masked, i.e., if the mask bit vector becomes all “1”.

The first priority select section 13 selects an empty buffer given the smallest number among remaining buffers masked by mask bit vectors. The second priority select section 14 selects an empty buffer given the smallest number among all buffers. The selector 15 selects firstly a buffer selected by the first priority select section 13. If no buffer is selected by the first priority select section 13, a buffer selected by the second priority select section 14 is selected.

Next, operation of the data buffer device will be described.

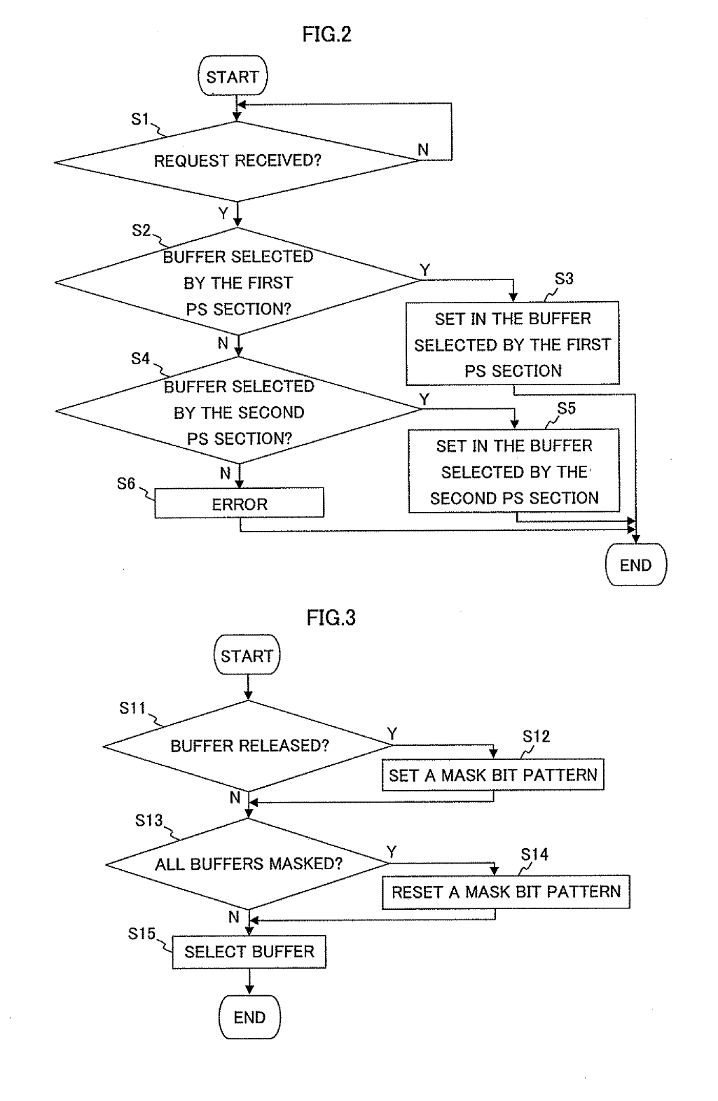

FIG. 2 is a flowchart showing an example of operation of the data buffer device according to the first embodiment. Suppose now that the REQ_QUEUE 11 has five buffers which are given buffer numbers of 0 to 4. The REQ_QUEUE 11 has a state V for each buffer number. If a buffer is used (valid), V=1 is set. The mask bit vector 12 has a state M of a mask bit pattern for each buffer number. If a buffer is masked, M=1 is set.

Firstly, the REQ_QUEUE 11 determines whether a request has been received or not (S1). If no request has been received (S1, N), the processing returns to the processing step S1. Next, the selector 15 determines whether or not the first priority select section (first PS section) 13 has selected a buffer (S2). Operation of buffer selection by the first priority select section 13 will be described later. If a buffer is selected by the first priority select section 13, the selector 15 sets a request in the buffer selected by the first priority select section 13 (S3). This flow is then terminated.

Otherwise, if no buffer is selected by the first priority select section 13 (S2, N), the selector 15 determines whether the second priority select section (second PS section) 14 has selected a buffer or not (S4). Operation of buffer selection by the second priority select section 14 will be described later. If a buffer is selected by the second priority select section 14, the selector 15 sets a request in the buffer selected by the second priority select section 14 (S5). This flow is then terminated. Otherwise, If no buffer is selected by the second priority select section 14 (S4, N), error processing is carried out (S6). This flow is then terminated.

FIG. 3 is a flowchart showing an example of operation of the first priority select section 13 according to the first embodiment. The first priority select section 13 determines whether or not a buffer is released (S11). If a buffer is released (S11, Y), a corresponding mask bit pattern in the mask bit vector 12 is set (S12). Next, the first priority select section 13 determines whether or not all buffers in the first priority select section 13 have been masked. That is, whether or not the mask bit vector 12 is set to all “1” is determined (S13). If the buffers are all masked (S13, Y), the mask bit vector 12 is reset (S14). Next, the first priority select section 13 selects a buffer (S15), and this flow is then terminated.

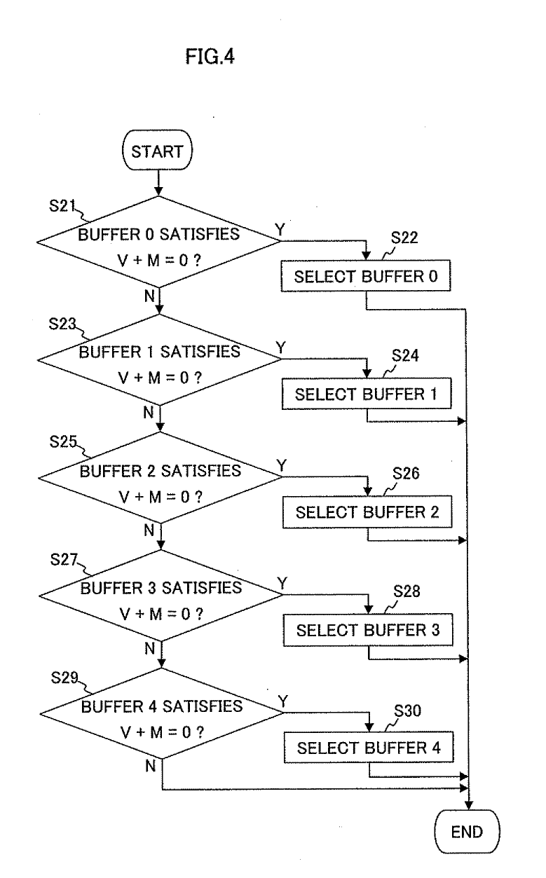

FIG. 4 is a flowchart showing an example of operation of buffer selection by the first priority select section according to the first embodiment. The first priority select section 13 firstly determines whether or not the buffer 0 satisfies V+M=0 (S21). That is, whether or not the buffer 0 is not masked and is unused is determined.

If V+M=0 is satisfied (S21, Y), the buffer 0 is selected (S22), and this flow is then terminated. If V+M=0 is not satisfied (S21, N), whether or not the buffer 1 satisfies V+M=0 is determined (S23). If V+M=0 is satisfied (S23, Y), the buffer 1 is selected (S24), and this flow is then terminated. If V+M=0 is not satisfied (S23, N), whether or not the buffer 2 satisfies V+M=0 is determined (S25). If V+M=0 is satisfied (S25, Y), the buffer 2 is selected (S26), and this flow is then terminated. If V+M=0 is not satisfied (S25, N), whether or not the buffer 3 satisfies V+M=0 is determined (S27). If V+M=0 is satisfied (S27, Y), the buffer 3 is selected (S28), and this flow is then terminated. If V+M 32 0 is not satisfied (S27, N), whether or not the buffer 4 satisfies V+M=0 is determined (S29). If V+M=0 is satisfied (S29, Y), the buffer 4 is selected (S30), and this flow is then terminated. If V+M=0 is not satisfied (S29, N), no buffer is selected, and this flow is then terminated.

FIG. 5 is a flowchart showing an example of operation of buffer selection by the second priority select section 14 according to the first embodiment. At first, the second priority select section 14 determines whether or not the buffer 0 satisfies V=0 (S31).

That is, whether or not the buffer 0 is unused is determined.

If V=0 is satisfied (S31, Y), the buffer 0 is selected (S32), and this flow is then terminated. If V=0 is not satisfied (S31, N), whether or not the buffer 1 satisfies V=0 is determined (S33). If V=0 is satisfied (S33, Y), the buffer 1 is selected (S34), and this flow is then terminated. If V=0 is not satisfied (S33, N), whether or not the buffer 2 satisfies V=0 is determined (S35). If V=0 is satisfied (S35, Y), the buffer 2 is selected (S36), and this flow is then terminated. If V=0 is not satisfied (S35, N), whether or not the buffer 3 satisfies V=0 is determined (S37). If V=0 is satisfied (S37, Y), the buffer 3 is selected (S38), and this flow is then terminated. If V=0 is not satisfied (S37, N), whether or not the buffer 4 satisfies V=0 is determined (S39). If V=0 is satisfied (S39, Y), the buffer 4 is selected (S40), and this flow is then terminated. If V=0 is not satisfied (S39, N), the buffer 0 is selected (S41), and this flow is then terminated.

Next, a specific example of operation of the data buffer device will be described.

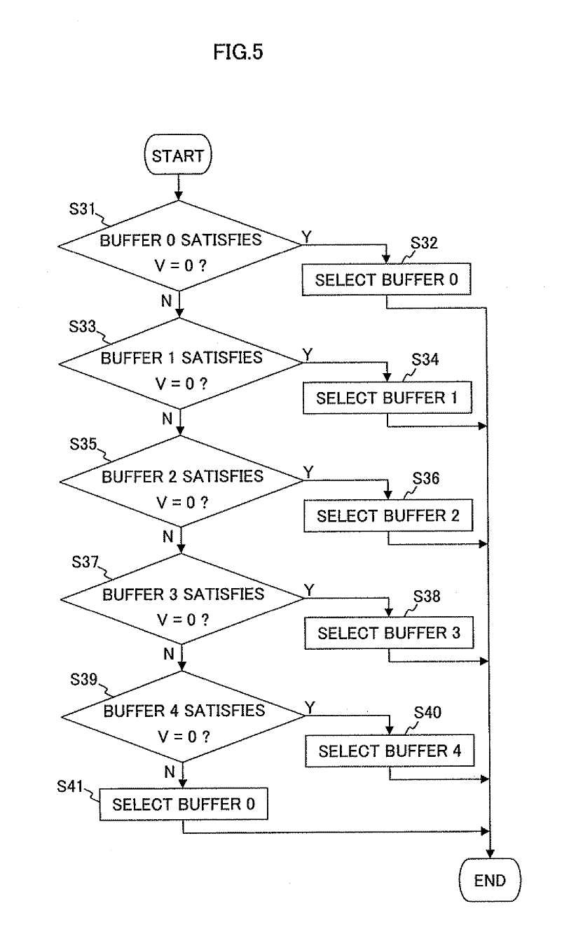

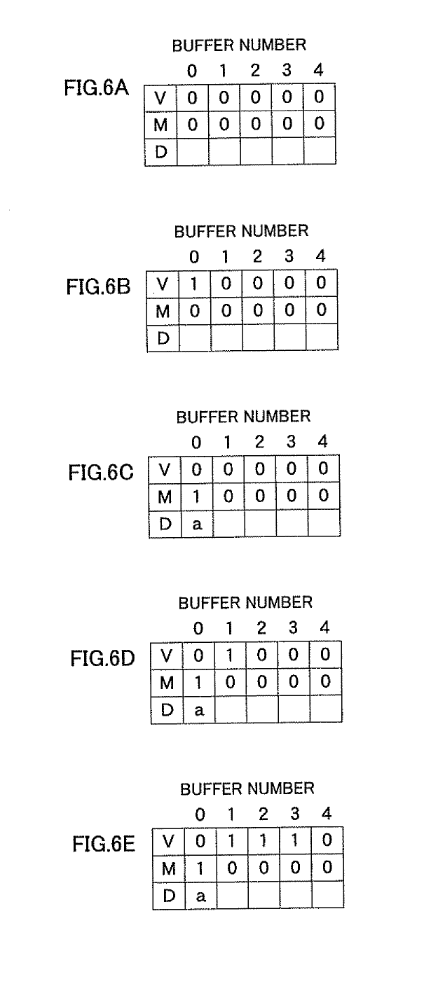

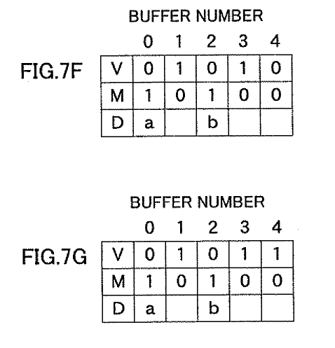

FIGS. 6A, 6B, 6C, 6D, 6E, 7F, and 7G show an example of specific operation of the data buffer device. These figures respectively show first to seventh states in this order. Suppose now that n which is the number of buffers in the REQ_QUEUE 11 is five and buffer numbers 0 to 4 are given to the buffers. For each buffer number, a buffer state V, a mask bit pattern state M, and an identifier D of remaining data (a, b, C, d, e, f, or g) are indicated. At first, the data buffer device is set in an initial state as in the first state shown in FIG. 6A. V and M are all “0”, and every D is empty.

Next, as in the second state shown in FIG. 6B, one buffer is used if one request arrives. The first priority select section 13 selects a non-masked and unused buffer given the smallest number. Here, the buffer 0 is selected and V=1 is set.

Next, if processing for the buffer 0 is completed, this buffer is released and V=0 is set, as in the third state shown in FIG. 6C. After releasing the buffer, M=1 is set. Data a remains in the buffer 0.

Next, as in the fourth state shown in FIG. 6D, one buffer is used if one request arrives. The first priority select section 13 selects a non-masked and unused buffer 1given the smallest number.

Next, as in the fifth state shown in FIG. 6E, two buffer is used if two requests arrive. The first priority select section 13 selects non-masked and unused buffers 2 and 3 given the smallest number.

Next, if processing for the buffer 2 is completed, this buffer is released and M=1 is set, as in the sixth state shown in FIG. 7F. Data b remains in the buffer 2.

Next, as in the seventh state shown in FIG. 7G, one buffer is used if one request arrives. The first priority select section 13 selects the non-masked and unused buffer 4 given the smallest number.

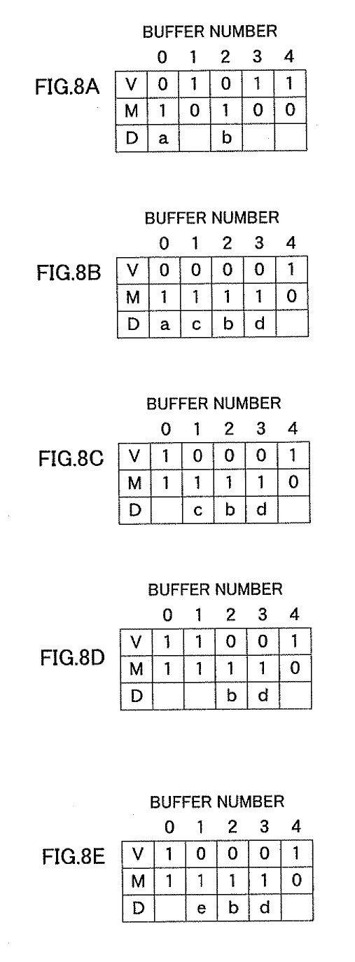

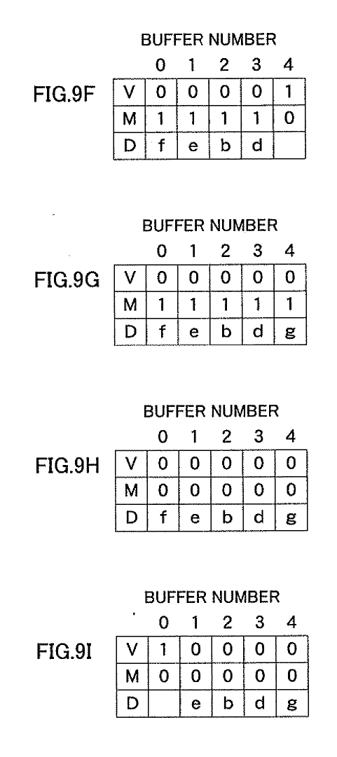

FIGS. 8A, 8B, 8C, 8D, 8E, 9F, 9G, 9H, and 9I show an example of specific operation relating to resetting of the mask bit vector according to the first embodiment. These figures respectively show first to ninth states in this order. These tables are written according to the same notation method as applied to FIG. 6A and the like. At first, the first state shown in FIG. 8A is a state after completion of the operation from FIG. 6A to FIG. 7F and expresses the same state as shown in FIG. 7G.

Next, if processing for the buffers 1 and 3 is completed as in the second state shown in FIG. 8B, these buffers are released and M=1 is set. Data c remains in the buffer 1, as well as data d in the buffer 3.

Next, if one request arrives as in the third state shown in FIG. 8C, there is no non-masked and unused buffer. Therefore, the second priority select section 14 selects the unused buffer 0 which is given the smallest number.

Next, if one request arrives as in the fourth state shown in FIG. 8D, there is no non-masked and unused buffer. Therefore, the second priority select section 14 selects the unused buffer 1 which is given the smallest number.

Next, if processing for the buffer 1 is completed as in the fifth state shown in FIG. 8E, this buffer is released and M=1 is set. Data e remains in the buffer 1.

Next, if processing for the buffer 0 is completed as in the sixth state shown in FIG. 9F, this buffer is released and M=1 is set. Data f remains in the buffer 0.

Next, if processing for the buffer 4 is completed as in the seventh state shown in FIG. 9G, this buffer is released and M=1 is set. Data g remains in the buffer 4.

Next, if the mask bit vector 12 is set to all “1” as in the eighth state shown in FIG. 9H, the mask bit vector 12 is reset. That is, M is set to M=0 for every buffers.

Next, as in the ninth state shown in FIG. 9I, one buffer is used if one request arrives. The first priority select section 13 selects the non-masked and unused buffer 0 given the smallest number.

In this embodiment, if the first priority select section 13 selects no buffer, the selector 15 selects a buffer selected by the second priority select section 14. However, the embodiment can be configured such that the selector 15 is omitted and the second priority select section 14 selects a buffer if no buffer is selected by the first priority select section 13.

### Second Embodiment

At first, a configuration of a cache device having a data buffer device will be described.

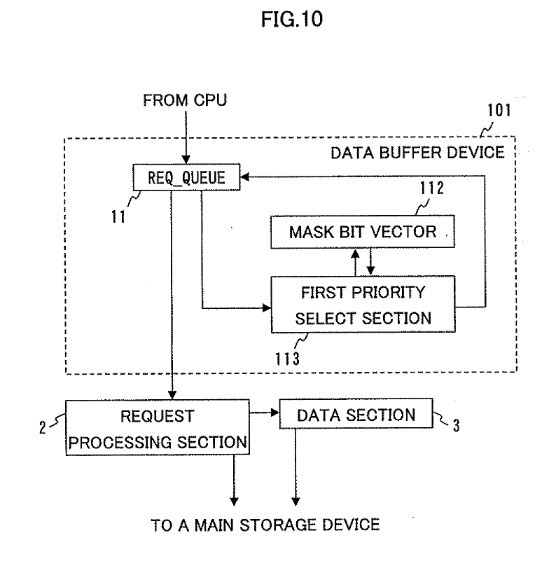

If existence of an empty buffer can be guaranteed logically, the second priority select section 14 and the selector 15 described above are not indispensable. FIG. 10 is a block diagram showing an example of a configuration of a cache device according to the second embodiment. In FIG. 10, the same reference symbols as those in FIG. 1 denote the same or equivalent components as or to those in FIG. 1. Description of those components will be omitted herefrom. This cache device has a data buffer device 101 in place of the data buffer device 1 in FIG. 1. The data buffer device 101 has a mask bit vector 112 in place of the mask bit vector 12 in the data buffer device 1, as well as a first priority select section 113 in place of the first priority select section 13. In addition, the second priority select section 14 and the selector 15 in the data buffer device 1 are omitted from the data buffer device 101.

In this embodiment, the mask bit vector 112 is reset, if no empty buffer remains after masking.

Next, operation of the data buffer device will be described.

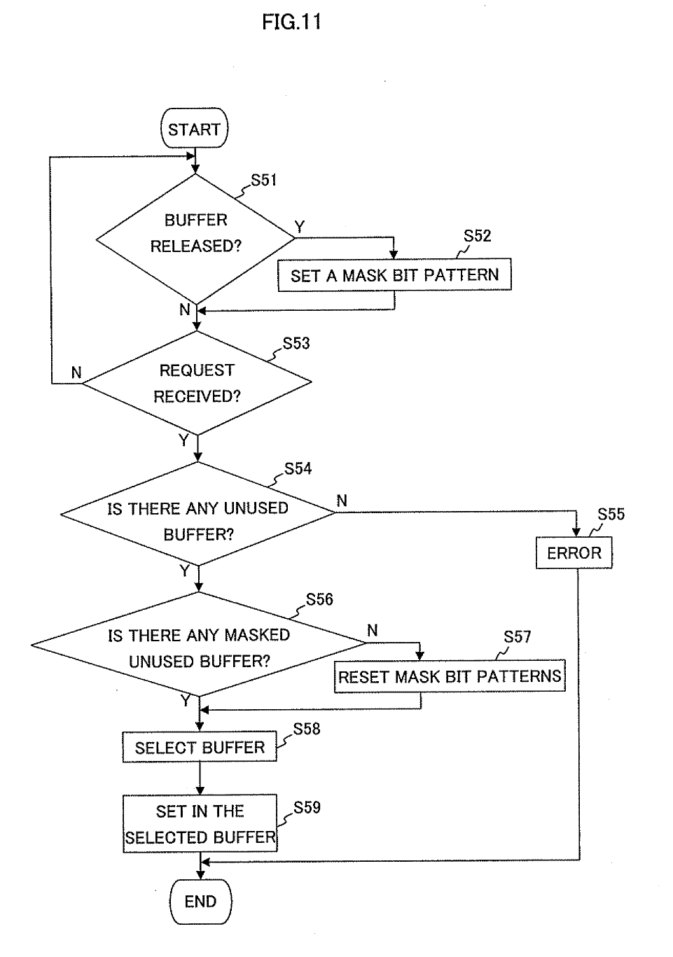

FIG. 11 is a flowchart showing an example of operation of the data buffer device according to the second embodiment. At first, the first priority select section 113 determines whether or not a buffer is released (S51). If a buffer is released (S51, Y), a corresponding mask bit pattern of the mask bit vector 112 is set (S52). Next, the REQ_QUEUE 11 determines whether a request has been received or not (S53). If no request has been received (S53, N), the processing returns to the processing step S51. Next, the first priority select section 113 determines whether or not there is an unused buffer (S54). If there is no unused buffer (S54, N), error processing is carried out (S55), and this flow is then terminated.

If there is an unused buffer (S54, Y), the first priority select section 113 determines whether or not an unused buffer remains among buffers after masking (S56). If there is no unused buffer among the buffers after masking (S56, N), the mask-bit vector 112 is reset (S57). Next, the first priority select section 113 selects a buffer (S58) and sets a request in the selected buffer (S59). This flow is then terminated. The first priority select section 113 performs the selection of a buffer through the same operation as shown in FIG. 4 in the first embodiment described above.

Next, a specific example of operation of the data buffer device will be described.

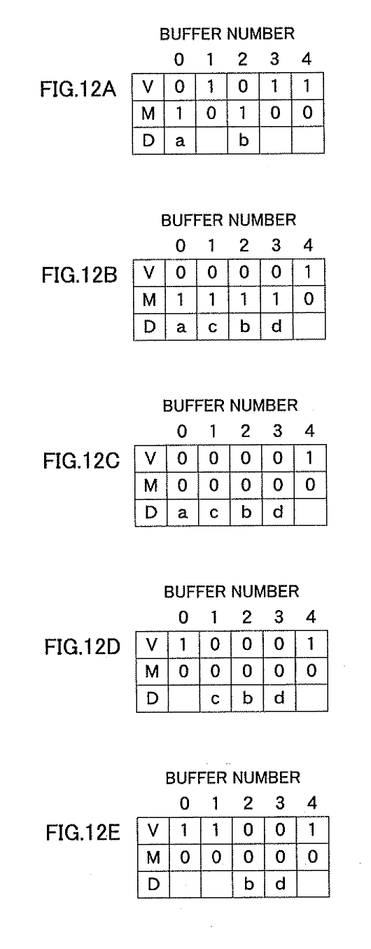

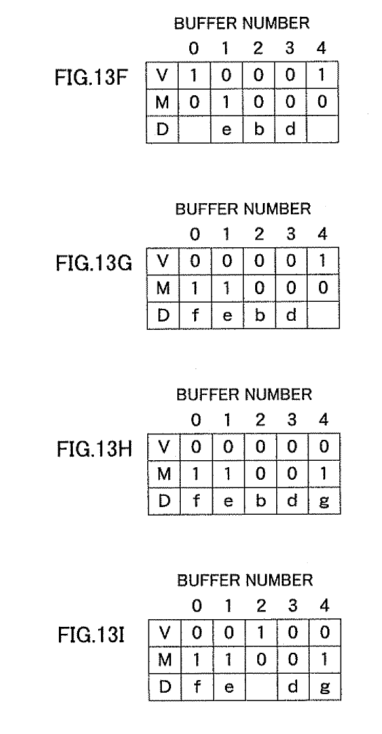

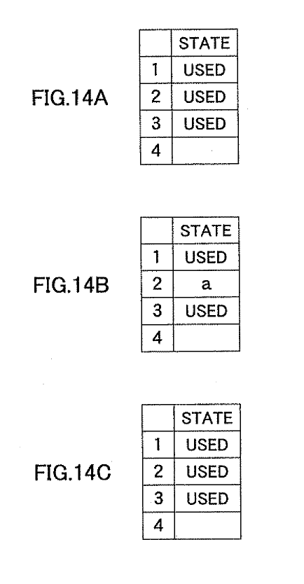

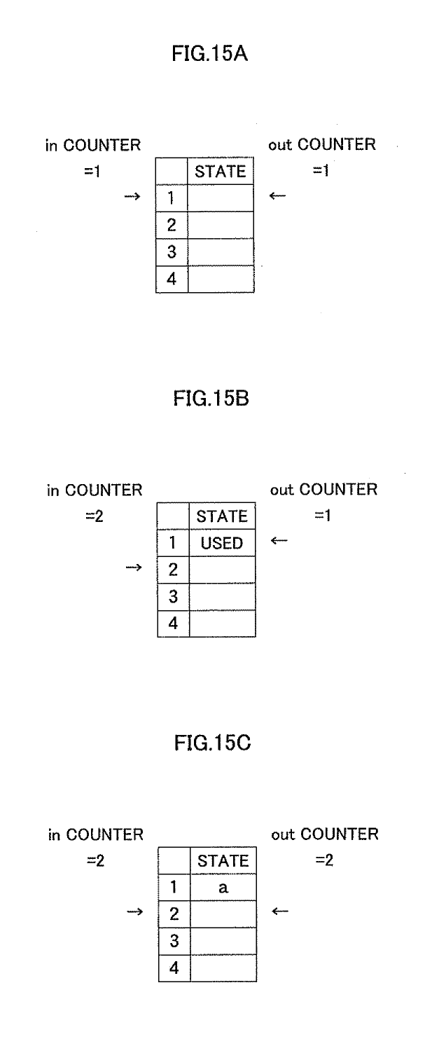

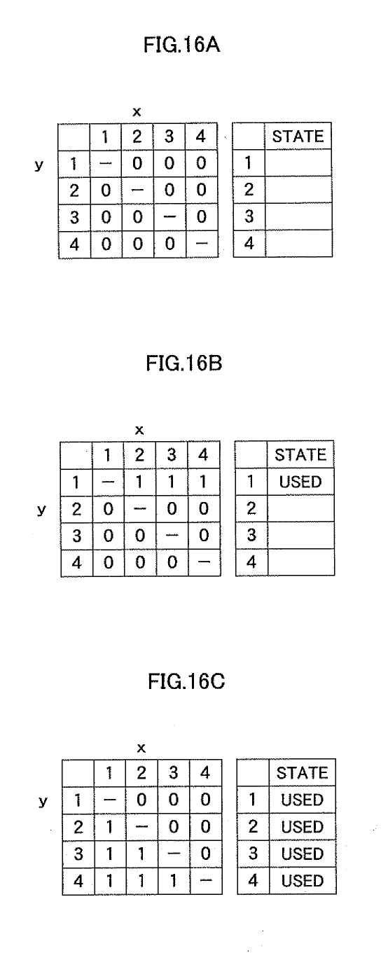

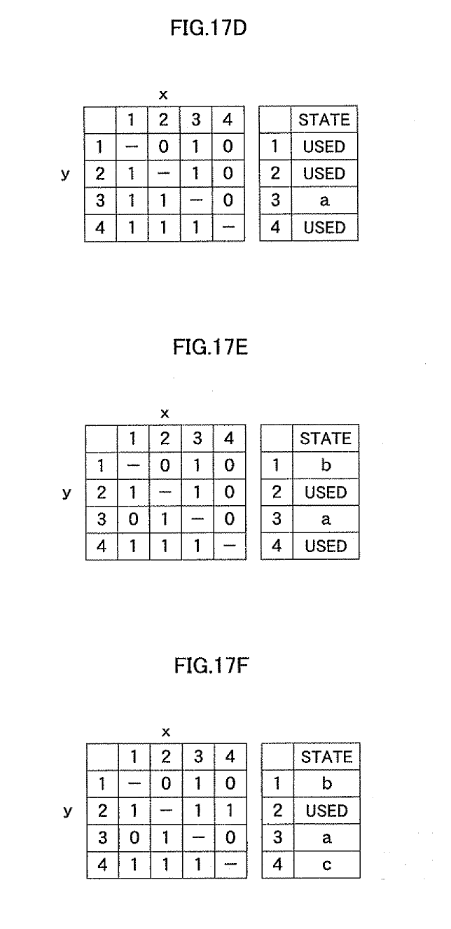

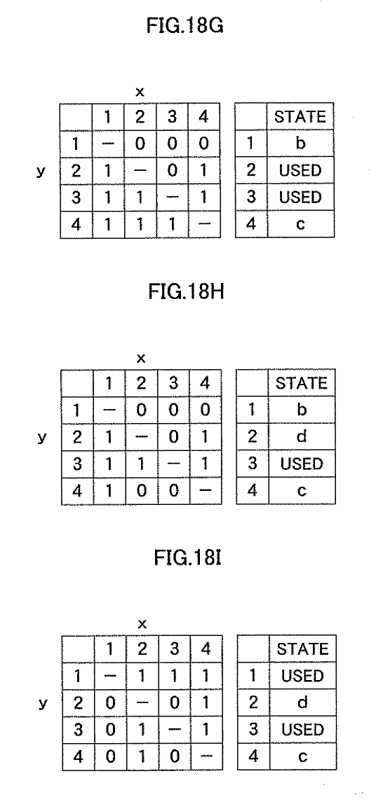

FIGS. 12A, 12B, 12C, 12D, 12E, 13F, 13G, 13H, and 13I show an example of specific operation relating to resetting of the mask bit vector according to the second embodiment. These figures respectively show first to ninth states in this order. These tables are written according to the same notation method as applied to FIG. 6A and the like. At first, the first state shown in FIG. 12A is a state after completion of operation from FIG. 6A to FIG. 7F and expresses the same state as shown in FIG. 7G.

Next, if processing for the buffers 1 and 3 is completed as in the second state shown in FIG. 12B, these buffers are released and M=1 is set. Data c remains in the buffer 1, as well as data d in the buffer 3.

Next, as in the third state shown in FIG. 12C, there is no non-masked and unused buffer any more. Therefore, the mask bit vector is reset. That is, M is set to 0 for all buffers.

Next, if one request arrives as in the fourth state shown in FIG. 12D, the first priority select section 113 selects the non-masked and unused buffer 0 which is given the smallest number.

Next, if one request arrives as in the fifth state shown in FIG. 12E, the first priority select section 113 selects the buffer 1 which is now a non-masked and unused buffer given the smallest number.

Next, if processing for the buffer 1 is completed, this buffer is released and M=1 is set, as in the sixth state shown in FIG. 13F. Data e remains in the buffer 1.

Next, if processing for the buffer 0 is completed, this buffer is released and M=1 is set, as in the seventh state shown in FIG. 13G. Data f remains in the buffer 0.

Next, if processing for the buffer 4 is completed, this buffer is released and M=1 is set, as in the eighth state shown in FIG. 13H. Data g remains in the buffer 4.

Next, if one request arrives as in the ninth state shown in FIG. 13I, the first priority select section 113 selects the buffer 2 which is a non-masked and unused buffer given the smallest number.

As can be understood from comparison between the state of FIG. 9I in the first embodiment and the state of FIG. 13I in the second embodiment, a penalty at the time of resetting in the second embodiment is smaller than that in the first embodiment. Accordingly, persistence of data improves.

By the data buffer device as described above, persistence of data. buffered in the past can be improved and use efficiencies of buffers can be equalized while restricting increase in circuit scale to be as small as possible.

### INDUSTRIAL APPLICABILITY

The present invention can be realized by very few circuits, i.e., n latches for buffers in n stages. Although data is not always erased in order from the oldest buffer, a remarkable improvement in persistence of data can be expected. Since activity ratios can be equalized between buffers. In tests concerning screening and the like, time required until all buffers are used become definitive. In addition, program patterns can be created so easily that test efficiencies improve.

1. A data buffer device that selects and uses buffers to improve persistence of data and uniformity in use frequency of the buffers, the device comprising:
plural buffers that store data and are given numbers;
a mask bit vector that has mask bit patterns to mask the plural buffers, respectively, and sets corresponding one of the mask bit patterns for a released buffer among the plural buffers; and
a priority select section that selects a buffer given the smallest number from buffers that are neither masked by the mask bit vector nor used among the plural buffers.

2. The data buffer device according to claim 1, wherein if there is no non-masked and unused buffer, the mask bit vector is reset.

3. A data buffer device that selects and uses buffers to improve persistence of data and uniformity in use frequency of the buffers, the device comprising:
plural buffers that store data and are given numbers;
a mask bit vector that has mask bit patterns to mask the plural buffers, respectively, and sets corresponding one of the mask bit patterns for a released buffer among the plural buffers;
a first priority select section that selects a buffer given the smallest number from buffers that are neither masked by the mask bit vector nor used among the plural buffers;
a second priority select section that selects a buffer given the smallest number from unused buffers among the plural buffers; and
a selector that selects one of the buffer selected by the first priority select section and the buffer selected by the second priority select section.

4. The data buffer device according to claim 3, wherein if all of the plural buffers are masked, the mask bit vector is reset.

5. A data buffer device that selects and uses buffers to improve persistence of data and uniformity in use frequency of the buffers, the device comprising:
plural buffers that store data and are given numbers;
a mask bit vector that has mask bit patterns to mask the plural buffers, respectively, and sets corresponding one of the mask bit patterns for a released buffer among the plural buffers;
a first priority select section that selects a buffer given the smallest number from buffers that are neither masked by the mask bit vector nor used among the plural buffers; and
a second priority select section that selects, if the first priority select section selects no buffer, a buffer given the smallest number from unused buffers among the plural buffers.

6. A cache device that selects and uses buffers to improve persistence of request and uniformity in use frequency of the buffers, the device comprising:
plural buffers that store requests and are given numbers;
a mask bit vector that has mask bit patterns to mask the plural buffers, respectively, and sets corresponding one of the mask bit patterns for a released buffer among the plural buffers;
a priority select section that selects a buffer given the smallest number from buffers that are neither masked by the mask bit vector nor used among the plural buffers;
a request processing section that processes one after another of the requests stored in the buffers; and
a data section that reads or writes data in response to the requests processed by the request processing section.

7. A cache device that selects and uses buffers to improve persistence of request and uniformity in use frequency of the buffers, the device comprising:
plural buffers that store requests and are given numbers;
a mask bit vector that has mask bit patterns to mask the plural buffers, respectively, and sets corresponding one of the mask bit patterns for a released buffer among the plural buffers;
a first priority select section that selects a buffer given the smallest number from buffers that are neither masked by the mask bit vector nor used among the plural buffers;
a second priority select section that selects a buffer given the smallest number from unused buffers among the plural buffers;
a selector that selects one of the buffer selected by the first priority select section and the buffer selected by the second priority select section;
a request processing section that processes one after another of the requests stored in the buffers; and
a data section that reads or writes data in response to the requests processed by the request processing section.

8. A cache device that selects and uses buffers to improve persistence of request and uniformity in use frequency of the buffers, the device comprising:
plural buffers that store requests and are given numbers;
a mask bit vector that has mask bit patterns to mask the plural buffers, respectively, and sets corresponding one of the mask bit patterns for a released buffer among the plural buffers;
a first priority select section that selects a buffer given the smallest number from buffers that are neither masked by the mask bit vector nor used among the plural buffers;
a second priority select section that selects, if the first priority select section selects no buffer, a buffer given the smallest number from unused buffers among the plural buffers;
a request processing section that processes one after another of the requests stored in the buffers; and
a data section that reads or writes data in response to the requests processed by the request processing section.

9. A data buffer control method that selects and uses buffers to improve persistence of data and uniformity in use frequency of the buffers, the method comprising:
a mask step that has mask bit patterns to mask the plural buffers, respectively, and sets corresponding one of the mask bit patterns for a released buffer among the plural buffers; and
a priority select step that selects a buffer given the smallest number from buffers that are neither masked by the mask step nor used among the plural buffers.

10. The data buffer control method according to claim 9, further comprising
a mask reset step that resets all of the mask bit patterns if there is not a buffer any more that is neither masked nor used among the plural buffers.

11. A data buffer control method that selects and uses buffers to improve persistence of data and uniformity in use frequency of the buffers, the method comprising:
a mask step that has mask bit patterns to mask the plural buffers, respectively, and sets corresponding one of the mask bit patterns for a released buffer among the plural buffers;
a first priority select step that selects a buffer given the smallest number from buffers that are neither masked by the mask step nor used among the plural buffers;
a second priority select step that selects a buffer given the smallest number from unused buffers among the plural buffers; and
a select step that selects one of the buffer selected by the first priority select step and the buffer selected by the second priority select step.

12. The data buffer control method according to claim 11, further comprising a reset step that resets all of the mask bit patterns if there is not a buffer any more that is not masked.

13. A data buffer control method that selects and uses buffers to improve persistence of data and uniformity in use frequency of the buffers, the method comprising:
plural buffers that store data and are given numbers;
a mask step that has mask bit patterns to mask the plural buffers, respectively, and sets corresponding one of the mask bit patterns for a released buffer among the plural buffers;
a first priority select step that selects a buffer given the smallest number from buffers that are neither masked by the mask step nor used among the plural buffers; and
a second priority select step that selects, if the first priority select step selects no buffer, a buffer given the smallest number from unused buffers among the plural buffers.
